(19) United States
(12) Patent Application Publication
(10) Pub. No.: US 2023/0100107 A1
(43) Pub. Date: Mar. 30, 2023

(54) APPARATUSES, METHODS, AND COMPUTER PROGRAM PRODUCTS FOR GENERATING AND PRESENTING COMPONENT SCORE INTERFACES WITHIN A MULTI-COMPONENT SYSTEM

(71) Applicants: ATLASSIAN PTY LTD., Sydney (AU); ATLASSIAN, INC., San Francisco, CA (US)

(72) Inventors: Jason Hinch, Sydney (AU); Bhakti Paranjpe, Sydney (AU); Patrick Hill, Austin, TX (US); Gregory Dame, San Francisco, CA (US); Jonathon Lowe, Sydney (AU); Jessica Brooke, San Francisco, CA (US)

(21) Appl. No.: 17/489,509

(22) Filed: Sep. 29, 2021

(51) Int. Cl. G06F 11/34; G06F 11/00; G06F 11/07; G06F 16/22; G06F 16/28; G06F 16/2457

(52) U.S. Cl. CPC G06F 11/3409; G06F 11/008; G06F 11/0793; G06F 16/2237; G06F 16/287; G06F 16/24573

(57) ABSTRACT

Methods, apparatuses, or computer program products provide for providing a component score interface within a multi-component system. A component metadata vector associated with a first component identifier may be retrieved from a component metadata repository. One or more component metadata values are extracted from the component metadata vector based at least in part on a first component score type. A first component score may be generated based at least in part on the one or more component metadata values extracted from the component metadata vector. Additionally, the first component score generation may comprise applying a unique weight value to each component metadata value in accordance with the first component score type. A component score interface comprising instructions for rendering a first component score interface element representing the first component score may be generated. Furthermore, the component score interface may be transmitted to a first client device.

### BACKGROUND

Conventional systems for managing components of systems in which multiple components interact suffer from many deficiencies and problems. Through applied effort, ingenuity, and innovation, these identified deficiencies and problems have been solved by developing solutions that are configured in accordance with the embodiments of the present disclosure, many examples of which are described in detail herein.

### BRIEF SUMMARY

Embodiments of the present disclosure relate to apparatuses, methods, and computer program products for providing a component score interface within a multi-component system. In example embodiments, a system for providing a component score interface within multi-component system includes one or more computers and one or more storage devices storing instructions that are operable, when executed by the one or more computers, to cause the one or more computers to retrieve, from a component metadata repository, a component metadata vector associated with a first component identifier, the component metadata vector comprising a plurality of records each comprising a component metadata record identifier and a component metadata value. In embodiments, the system comprising one or more computers and one or more storage devices storing instructions that are further operable, when executed by the one or more computers, to cause the one or more computers to, based at least in part on a first component score type, extract one or more component metadata values from the component metadata vector, wherein the first component score type defines the one or more component metadata values required from the component metadata vector for generation of a first component score associated with the first component score type. In embodiments, the system comprising one or more computers and one or more storage devices storing instructions that are further operable, when executed by the one or more computers, to cause the one or more computers to generate the first component score based at least in part on the one or more component metadata values extracted from the component metadata vector, wherein generating the first component score comprises applying a unique weight value to each component metadata value of the one or more component metadata values in accordance with the first component score type. In embodiments, the system comprising one or more computers and one or more storage devices storing instructions that are further operable, when executed by the one or more computers, to cause the one or more computers to generate a component score interface comprising instructions for rendering a first component score interface element representing the first component score, the component score interface configured for graphical rendering via a display device of a first client device. In embodiments, the system comprising one or more computers and one or more storage devices storing instructions that are further operable, when executed by the one or more computers, to cause the one or more computers to transmit the component score interface to the first client device.

In embodiments, the system comprising one or more computers and one or more storage devices storing instructions that are further operable, when executed by the one or more computers, to cause the one or more computers to update the first component score in response to detection of a change in one or more of the one or more component metadata values required from the component metadata vector.

In embodiments, a component score type is one or more of a security score, compliance score, health score, operational health score, readiness score, reliability score, or a custom score.

In embodiments, the first component score type is associated with a first metadata values set required from the component metadata vector for generation of the first component score.

In embodiments, the system comprising one or more computers and one or more storage devices storing instructions that are further operable, when executed by the one or more computers, to cause the one or more computers to generate the first component score in response to receiving a component score interface request from the first client device.

In embodiments, the system comprising one or more computers and one or more storage devices storing instructions that are further operable, when executed by the one or more computers, to cause the one or more computers to responsive to detecting that the first component score is below a component score threshold associated with the component score type, transmit a component score notification to a second client device.

In embodiments, the system comprising one or more computers and one or more storage devices storing instructions that are further operable, when executed by the one or more computers, to cause the one or more computers to generate a second component score interface comprising instructions for rendering a plurality of component score interface elements each representing unique component scores associated with a first component associated with the first component identifier, the second component score interface configured for graphical rendering via the display device of the first client device. In embodiments, the system comprising one or more computers and one or more storage devices storing instructions that are further operable, when executed by the one or more computers, to cause the one or more computers to transmit the second component score interface to the first client device.

In embodiments, the one or more values of the component score comprise one or more of a percentage, count, or duration.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example component management system within which one or more embodiments of the present disclosure may operate.

FIG. 2 is a block diagram of an example component management apparatus configured in accordance with one or more embodiments of the present disclosure.

FIGS. 3A-B illustrate example systems in accordance with one or more embodiments of the present disclosure.

FIG. 4 illustrates a flowchart of example operations for performing a first component score generation in accordance with embodiments of the present disclosure.

FIG. 5 illustrates a flowchart of example operations for detecting if a first component score is below a component score threshold in accordance with embodiments of the present disclosure.

FIG. 6 illustrates a flowchart of example operations for performing a second component score generation in accordance with embodiments of the present disclosure.

FIG. 7 illustrates an example user interface in accordance with one or more embodiments of the present disclosure.

FIG. 8 illustrates an example user interface in accordance with one or more embodiments of the present disclosure.

FIG. 9 illustrates an example user interface in accordance with one or more embodiments of the present disclosure.

FIG. 10 illustrates an example component scorecard in accordance with one or more embodiments of the present disclosure.

FIG. 11 illustrates an example user interface for one or scorecards in accordance with one or more embodiments of the present disclosure.

FIG. 12 illustrates an example of component scorecard component type symbols in accordance with one or more embodiments of the present disclosure.

### DETAILED DESCRIPTION OF VARIOUS EMBODIMENTS

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present disclosure address technical problems associated with efficiently and reliably managing components of a multi-component system where multiple components/resources and/or layers of components/resources interact with one another in several complex manners. The disclosed techniques can be utilized by a component management system to provide a component score interface within the multi-component system to enhance effectiveness and/or efficiency of performing multi-component system management with respect to complex multi-component systems.

A complex application framework (e.g., a cloud application framework) is typically characterized by a large number of the application components (e.g., services) that are offered by the application framework. Those application components typically include a large number of frontend application components and/or a large number of backend application components. Because of the numerosity of the application components that are typically offered by a complex application framework, a large number of data objects may be generated at a time interval, subsets of which may relate to events, incidents, changes, component requests, scheduling, alerting, workflows and/or other dynamic data associated with the application framework. As such, managing data and/or computing resources related to application components of an application framework is generally difficult. Additionally, in some scenarios, it is generally difficult to visualize meaningful information regarding application components in an intuitive manner, particularly given the complex and dynamic nature of the application framework. For example, consider a scenario in which it is desirable to view the overall operational health of an application component within the application framework such that the overall operational health of said application component is up-to-date. Such an application component is subject to change in real-time based on a variety of factors, making an accurate and up-to-date operational health score non-trivial to determine. Further complicating matters and as previously mentioned, an application framework may include a larger number of application components, all of which are subject to change in real-time, making an accurate and up-to-date operational health score for each application component difficult to accurately determine.

Typically, management of application components of an application framework involves manual employment of spreadsheets and/or central storage with component-specific programming language files (e.g., JavaScript Object Notation (JSON) files, YAML files, etc.). However, typical techniques for managing application components of an application framework do not provide an opinionated data-model for tracking application components. Furthermore, typical techniques for managing application components of an application framework generally lack automation to facilitate the managing. It is also generally difficult to find information with typical techniques for managing application components of an application framework (e.g., due to disparate locations for data related to the application components, etc.).

As illustrated above, without being able to provide a component score interface within the multi-component system, a user may not be able to view the operational health (e.g., or other health or evaluation metric) of each component of the multi-component system, which may result in ineffective components going unnoticed and may create problems for one or more other components. This problem is exasperated as the number of application components in a complex multi-component system grows larger, which in turn leads to the big data processing problem of real-time processing of a large number of data objects generated as a result of an event associated with the complex multi-component system. As this description shows, a conventional management approach that relies on manual processing and/or individual processing of data objects generated by application components is not scalable, as it becomes increasingly inefficient to process data objects manually and/or on an individual level as the complexity of a multi-component system grows.

To address the above-described challenges related to managing components associated with multi-component systems, various embodiments of the present disclosure are directed to systems, apparatuses, methods and/or computer program products for providing a component score interface related to a component management system. The component management system may be, for example, a system that manages components (e.g., application components, application micro-components, services, microservices, etc.) of an application framework (e.g., a cloud application framework). Components of the application framework may include, for example, components related to one or more layers of the application framework.

In one or more embodiments, the component management system may generate a component score for one or more component score types for one or more components of the multi-component system. In some embodiments, the component management system may be configured to store a metadata values set required from the component metadata vector for each component score type of the component. The component management system may be configured to retrieve a component metadata vector comprising a plurality of component metadata values for a component using the corresponding component identifier. The component management system may then extract one or more component metadata values of the plurality of component metadata values and apply a unique weight, such as the weight indicated by the metadata values set, to each component metadata value to generate a component score for the component score type. The component management system may generate component score interface instructions for rendering the component score interface element for display on one or more client devices and provide the component score interface to the one or more client devices.

By using the described techniques, various embodiments of the present disclosure provide a component score interface indicative of the operational health of one or more components in the multi-component system. Thus, component management system provides for an up-to-date and real-time or near real-time view of each component's operational health prior to such problems occurring, such as by generating a component score for one or more component score types for a component and providing these component scores in a component score interface. This allows one or more users to observe the operational health of each component, thus ultimately sparing computational resources by allowing for preventative measures and/or by pinpointing the cause for low operational health scores. Various embodiments of the present disclosure additionally or alternatively provide for a component score type to be customized to address the specific needs of each user and/or entity associated with a user, quicker access to the relevant information with respect to components of an application framework, improved understanding of the operational health of a component of an application framework, and/or improved usability of components of an application framework.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

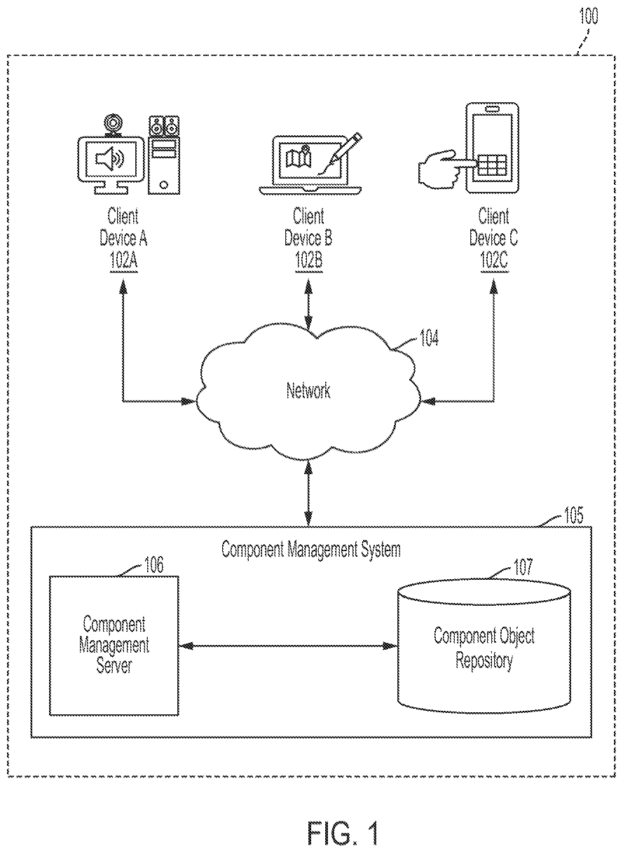

The term “server computing device” refers to a combination of computer hardware and/or software that is configured to provide a component to a client device. An example of a server computing device is the component management system 105 of FIG. 1. In some embodiments, a server computing device communicates with one or more client computing devices using one or more computer networks.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “application framework” refers to a computing environment associated with one or more computing devices and one or more applications, where the environment enables the discovery of insights associated with components supporting at least one application. In some embodiments, the components are associated directly or indirectly with an application supported by the components. In some embodiments, the components can support the application over one or more communication networks. The application framework can include one or more applications to generate and update a repository of collected information for each component (e.g., component object repository). Accordingly, the application framework can provide for the collection of information, in the form of component objects, to generate work graphs associated with one or more components. In some embodiments, applications can compare information collected for a component with information collected for another component or a predefined threshold criteria.

The term “application,” “app,” or similar terms refer to a computer program or group of computer programs designed for use by and interaction with one or more networked or remote computing devices. In some embodiments, an application refers to a mobile application, a desktop application, a command line interface (CLI) tool, or another type of application. Examples of an application comprise workflow engines, component desk incident management, team collaboration suites, cloud components, word processors, spreadsheets, accounting applications, web browsers, email clients, media players, file viewers, videogames, and photo/video editors. An application can be supported by one or more components either via direct communication with the component or indirectly by relying on a component that is in turn supported by one or more other components.

The term “component” refers to a computer functionality or a set of computer functionalities, such as the retrieval of specified information or the execution of a set of operations, with a purpose that different clients can reuse for their respective purposes, together with the policies that should control its usage, for example, based on the identity of the client (e.g., an application, another component, etc.) requesting the component. Additionally, a component may support, or be supported by, at least one other component via a component dependency relationship. For example, a translation application stored on a smartphone may call a translation dictionary component at a server in order to translate a particular word or phrase between two languages. In such an example the translation application is dependent on the translation dictionary component to perform the translation task. In some embodiments, a component is offered by one computing device over a network to one or more other computing devices. Additionally, the component may be stored, offered, and utilized by a single computing device to local applications stored thereon and in such embodiments a network would not be required. In some embodiments, components may be accessed by other components via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, components may be configured to capture or utilize database information and asynchronous communications via message queues (e.g., Event Bus). Non-limiting examples of components include an open source API definition format, an internal developer tool, web based HTTP components, databased components, and asynchronous message queues which facilitate component-to-component communications. In some embodiments, a component can represent an operation with a specified outcome and can further be a self-contained computer program. In some embodiments, a component from the perspective of the client (e.g., another component, application, etc.) can be a black box (e.g., meaning that the client need not be aware of the component's inner workings). In some embodiments, a component may be associated with a type of feature, a an executable code, two or more interconnected components, and/or another type of component associated with an application framework. In some embodiments, a component may correspond to a service. Additionally or alternatively, in some embodiments, a component may correspond to a library (e.g., a library of components, a library of services, etc.). Additionally or alternatively, in some embodiments, a component may correspond to one or more modules. Additionally or alternatively, in some embodiments, a component may correspond to one or more machine learning models. For example, in some embodiments, a component may correspond to a service associated with a type of service, a service associated with a type of library, a service associated with a type of feature, a service associated with an executable code, two or more interconnected services, and/or another type of service associated with an application framework.

The term “service” refers to a type of component. In some embodiments, a service provides a visual representation of one or more data structures. In some embodiments, a service is configured for viewing data, searching for data, creating data, updating data, managing relationships among data, assigning attributes related to data, and/or storing data associated with one or more data structures. In some embodiments, a service is configured as a system, tool or product to facilitate viewing data, searching for data, creating data, updating data, managing relationships among data, assigning attributes related to data, and/or storing data associated with one or more data structures. In some embodiments, a service comprises a set of metadata attributes associated with a technical capability, a technical configuration, an application capability, an application configuration, and/or another metadata attribute. In some embodiments, a service is published to one or more client devices via one or more APIs. In some embodiments, a service is a logical representation of an application stack. In some embodiments, a service corresponds to one or more microservices.

The term “microservices” refers to a set of services that are interconnected and independently configured to provide a monolith service. In some embodiments, a microservice is configured with one or more APIs integrated with one or more other microservices and/or one or more other applications. In some embodiments, a microservice is a single-function module with a defined set of interfaces and/or a defined set of operations configured to integrate with one or more other microservices and/or one or more other applications to provide a monolith service.

The term “library” refers to a collection of objects (e.g., a collection of component objects, a collection of service objects, etc.), a collection of functions, and/or a collection of processing threads associated with one or more components.

The term “component metadata vector” refers to a data structure that represents at least one property (e.g., piece of metadata) associated with a component. The component metadata vector can take the structural form of a vector or other appropriate data structure for representing the component and its associated properties and/or data. For example, a component metadata vector can represent a web component provided by a server to a plurality of other computing devices over a wired and/or wireless network and, as such, the component metadata vector can contain properties associated with the web component such as an IP address, API, or the like. Component metadata vector can be configured to follow a predefined format, such that an application can collect and store substantially similar data for each represented component in its respective component metadata vector. Data or metadata collected for each component to be represented by an associated component metadata vector can be collected directly from the component itself, a computing device associated with the component, and/or from an existing repository of component objects. In some embodiments, a component metadata vector can also represent an application or other non-component computer program that utilizes at least one component. In some embodiments, the component metadata vector may comprise a component metadata vector identifier and an attribute (e.g., a component metadata value), the attribute comprising an array of name and value pairs with properties associated with the component. For example, a component metadata vector may be structured as: Component {Id: graph-component-1 Attributes: [{name: geolocations, value: [us, eu]}, {name: level, value: HIGH PRIORITY},]}. Each record of a component metadata vector may be associated with a component metadata record identifier, which refers to one or more items of data by which a component metadata record may be uniquely identified.

The term “component identifier” refers to one or more items of data by which a particular component may be uniquely identified.

The terms “internal component,” “internal resource,” or similar terms refer to a program, application, platform, or component that is configured by a developer to provide functionality to another one or more of their programs, applications, platforms, or components, either directly or indirectly through one or more other components, as opposed to using an external component. Internal components operate on a compiled code base or repository that is at least partially shared by an application which utilizes the functionality provided by the internal component. In some embodiments, the application code base and the internal component code base are hosted on the same computing device or across an intranet of computing devices. An application communicates with internal components within a shared architectural programming layer without external network or firewall separation. In some embodiments, an internal component is used only within the application layer which utilizes the internal components functionality. Information related to internal components can be collected and compiled into component objects which can also be referred to as internal component objects. An example embodiment of an internal component is a load balancer configured for routing and mapping API and/or component locations. Internal components may be configured for information-based shard routing, or in other words, routing and mapping API and/or component locations based on predefined custom component requirements associated with an application. For example, an internal component may be configured to identify where communication traffic originates from and then reply to the communications utilizing another component for reply communication.

The terms “external component,” “external resource,” “remote resource,” or similar terms refer to a program, application, platform, or component that is configured to communicate with another program, application, platform, or component via a network architecture. In some embodiments, communications between an external component and an application calling the external component takes place through a firewall and/or other network security features. The external component operates on a compiled code base or repository that is separate and distinct from that which supports the application calling the external component. The external components of some embodiments generate data or otherwise provide usable functionality to an application calling the external component. In other embodiments, the application calling the external component passes data to the external component. In some embodiments, the external component may communicate with an application calling the external component, and vice versa, through one or more application program interfaces (APIs). For example, the application calling the external component may subscribe to an API of the external component that is configured to transmit data. In some embodiments, the external component receives tokens or other authentication credentials that are used to facilitate secure communication between the external component and an application calling the external component in view of the applications network security features or protocols (e.g., network firewall protocols). An example embodiment of an external component may include cloud components (e.g., AWS®).

The term “weight value” refers to a programmatically, configurable, or pre-defined weighting applied to one or more component metadata values when determining a component score. Weight values utilized in generating a particular score may be defined according to the component score type being generated.

The term “component label” refers to a programmatically, configurable, or pre-defined factor configured to influence the component score for a component scorecard. Each component label is associated with a weight value indicative of how heavily to weight the particular component label relative to one or more other component labels in a component scorecard. In some embodiments, a component label is defined by a user. In some embodiments, a component label may be graphically represented within an interface and associated with a component or a component scorecard. It will be appreciated that a component label may be associated with more than one component or component scorecard, and a component or a component scorecard may be associated with one or many component labels.

The term “component metadata” refers to one or more data items or elements associated with a component that are collected and represented as part of a component metadata vector. The component metadata may refer to any information associated with the component represented by the component metadata vector, such as, for example, component dependency relationships, component object identifiers, deployment events (e.g., including counts of deployment events, frequency of deployment events, timestamps associated with deployment events, comparisons of timestamps associated with deployment events over time, and the like), performance metrics for the respective component (e.g., processor usage, access logs, crash reports, etc.), encryption keys, hardware requirements, associated computing devices, IP addresses, API compatibility, a host computing device's physical location (e.g., GPS coordinates, country name, etc.), the like, or combinations thereof. In some embodiments, the component metadata may be one or more encrypted or unencrypted files, for example, JSON files, XML files, SOAP files, HTML, files, the like, or combinations thereof. In some embodiments, component metadata may comprise one or more of a component metadata record identifier and an attribute associated with a component. In embodiments, the attribute may comprise an array of name and value pairs representative of properties of the component such as a component host name and/or geolocation. For example, component metadata may be structured with attributes associated with a host component as: Host {Id: graph-host-1 Attributes: [{name: geolocations, value: [us, eu]}, {name: name, value: hostx.foo.internal.company.net},]}. In some embodiments, component metadata may be fetched from a host system or server for one or more components.

The term “multi-component system” refers to a system (e.g., a server system, a cloud-based system, etc.) where multiple components, multiple resources associated with components, multiple layers of components, and/or multiple layers of resources interact with one another in several complex manners.

The term “component score interface request” refers to a signal received by one or more computing devices (e.g., servers, systems, platforms, etc.) which are configured to cause a component management system associated with the one or more computing devices to generate and/or return one or more component score interface elements associated with one or more components. The component score interface request may be received via a component management interface, an API, a communication interface, the like, or combinations thereof. In one or more embodiments, the component score interface request may be generated by a client device via one or more computer program instructions.

The term “component score interface element” refers to a formatted version of one or more component scores to facilitate a visualization and/or human interpretation of data associated with the one or more component scores via an electronic interface. In one or more embodiments, an component score interface element may additionally or alternatively be formatted for transmission via one or more networks. In one or more embodiments, an component score interface element may include one or more graphical elements and/or one or more textual elements.

The term “visualization” refers to visual representation of data (e.g., one or more component vector score elements) to facilitate human interpretation of the data. In some embodiments, visualization of data includes graphic representation and/or textual representation of data.

The term “component score interface” refers to an electronic interface, which may include multiple areas, where each area may be situated in relation to one or more other interface areas of the electronic interface. An interface area may be comprised of groupings of pixels, or may be defined according to coordinates of a display device configured to render the interface. A size of an interface may be adjusted according to parameters associated with the display device. An interface area may include one or more interface elements. For example, an interface element may include a visualization. In certain embodiments, an interface area may include one or more graphical elements and/or or more textual elements. In certain embodiments, an interface area may be void of an interface element and/or a visualization. In certain embodiments, an interface area may include a search graphical control element and/or one or more other interactive interface elements.

The term “ownership” refers to identification of one or more client identifiers that are assigned as an owner, manager, and/or a creator of a component.

The term “structured metadata” refers to data regarding an ordering, grouping and/or a clustering of metadata. In some embodiments, structured metadata is associated with a type of metadata, a version of metadata, a relationship between metadata, and/or a classification for metadata.

The term “component scorecard” refers to graphics information that quantifies data associated with one or more components. In one or more embodiments, a component scorecard includes one or more key performance indicators, one or more quality indicators, one or more quantity indicators, and/or one or more other metrics that quantifies data associated with one or more components. Each component scorecard can include or be based upon one or more component labels, each with an associated weight value. The component scorecard may also be associated with a component scorecard component type. A component scorecard component type is a categorical value indicative of the type of component associated with the particular component scorecard. For example, the component scorecard component type may include a service type, library type, application type, and/or other type.

The term “component score type” refers to an attribute of which the component scorecard is representative of. In one or more embodiments, a component score type may include but is not limited to a security score, compliance score, health score, operational health score, reliability score, readiness score, or a custom score. In one or more embodiments, a component score type may be associated with a particular component type, such as an application, library, or service component type. Further, a component score type may be associated with an importance classification indicative of how essential a particular component score type is. Such importance classification may include but is not limited to a required, recommended, or custom importance classification. Component score types classified as a required will automatically be applied to a component when generating a component scores for a component scorecard and may not be removed. Component score types classified as recommended will be suggested as component score types to add to a component scorecard. Component score types classified as custom may be primarily focused on specific use cases for a particular user, team, department, etc. and may be added to a component scorecard by one or more users. Furthermore, each component score type is associated with a metadata values set required from the component metadata vector for generation of a component score. In some embodiments, the metadata values set for a component score type defines a maximum component score and a unique weight value for one or more component metadata values.

The term “component score” refers to a quantifiable value associated with a particular component score type. In some embodiments, a component score value may be represented as a percentage, count, duration, and/or the like. In some embodiments, the component score is determined based at least in part on the metadata values set associated with a particular component score type. A component score for a particular component score type may be an integer between 0 and a maximum component score, such as a maximum component score defined by the metadata values set associated with the component score type. In some embodiments, the component score may be visually depicted in a variety of ways. For example, the component score may be colored such that the associated health described by the component score is depicted. The color of a component score may be indicative of whether the component score satisfies and/or fails one or more associated component score thresholds. For example, a component score that satisfies each component score thresholds, may be colored green. As another example, a component score that satisfies one or more component score thresholds and also fails one or more component score thresholds, may be colored yellow. As yet another example, a component score that fails one or more component score thresholds may be colored red. In some embodiments, the component score may be depicted in one or more component views. For example, a component view may include representing the component score in a circular representation. As another example, a component view may include representing the component score in a list view.

The term “component score threshold” refers to a value which a component score for a component score type must satisfy. In some embodiments, component scores which do not satisfy the component score threshold are not considered to be of satisfactory operational health. In one or more embodiments, the component score threshold is configurable by one or more users such that the component score threshold may be adjusted according to a user's desired preferences. In one or more embodiments, the component score threshold is initially configured to a default value. In one or more embodiments, if a component score fails to satisfy a component score threshold, for instance, such as when a component score is below a component score threshold, one or more actions may be taken in response. In one or more embodiments, the one or more actions may include but is not limited to transmitting a component score notification to a client device and/or activating a corrective action associated with the component associated with a component identifier.

The term “aggregate component score” refers to a quantifiable value associated with one or more component scorecards for a particular organization or computing platform. In some embodiments, an aggregate component score value may be represented as a percentage, count, duration, and/or the like. In some embodiments, the aggregate component score is determined based at least on each component score for the one or more component scorecards. In some embodiments, the aggregate component score is generated based at least in part on whether each component score for the one or more component scorecards satisfies a respective component score threshold. In some embodiments, the aggregate component score may be visually depicted in a variety of ways. For example, the aggregate component score may be colored such that the associated overall health for the component scorecards associated with the particular organization is depicted. The color of an aggregate component score may be indicative of whether the aggregate component score satisfies and/or fails one or more associated aggregate component score thresholds. For example, an aggregate component score that satisfies each aggregate component score thresholds, may be colored green. As another example, an aggregate component score that satisfies one or more aggregate component score thresholds and also fails one or more aggregate component score thresholds, may be colored yellow. As yet another example, an aggregate component score that fails one or more aggregate component score thresholds may be colored red. In some embodiments, the aggregate component score may be depicted in one or more component views. For example, a component view may include representing the aggregate component score in a circular representation.

The term “aggregate component score threshold” refers to a value for an aggregate component score must satisfy. In some embodiments, an aggregate component score which does not satisfy the aggregate component score threshold may indicate the organization is not of satisfactory operational health based at least in part on the one or more component scorecards associated with the organization. In one or more embodiments, the aggregate component score threshold is configurable by one or more users such that the aggregate component score threshold may be adjusted according to a user's desired preferences. In one or more embodiments, the aggregate component score threshold is initially configured to a default value. In one or more embodiments, if an aggregate component score fails to satisfy an aggregate component score threshold, for instance, such as when one or more component scorecards are associated with one or more component scores below a component score threshold, one or more actions may be taken in response. In one or more embodiments, the one or more actions may include but is not limited to transmitting an aggregate component score notification to a client device.

The term “component score notification” refers to an indication indicative of a component score, component score status, or otherwise a component relating to a component scorecard. In one or more embodiments, a component score notification is transmitted to one or more client devices in an instance a component score fails to satisfy a component score threshold, for instance, such as when a component score fails to satisfy a component score threshold. In some embodiments, a component score notification may be indicative of one or more causes of why a component score failed to satisfy a component score threshold.

The term “corrective action” refers to one or more actions performed to rectify an issue associated with one or more component scores. In some embodiments, one or more actions may be performed in an instance a component score fails to satisfy a component score threshold. In one or more embodiments, one or more actions may include determining one or more causes of why a component score failed to satisfy a component score threshold, transmitting a component score notification, performing one or more tasks associated with correcting the cause of why a component score failed to satisfy a component score threshold, etc.

The term “event” refers to one or more changes and/or one or more incidents related to one or more components. In some embodiments, an event may be associated with a unique identifier, one or more attributes, one or more tags, one or more classifications, one or more source identifiers, one or more object types, and/or other context data. Additionally, in some embodiments, an event may be triggered via one or more components. In some embodiments, an event may be associated with an event stream. In some embodiments, an event can be related to one or more changes and/or one or more incidents with respect to a component metadata repository. In some embodiments, an event can be related to a client device that interacts with a component. For example, in some embodiments, an event can be related to one or more changes and/or one or more incidents initiated via a display screen of a client device.

The term “event stream” refers to a collection of events related to one or more components. For example, an event stream can include a first event associated with at least one component, a second event associated with the at least one component, a third event associated with the at least one component, etc.

Thus, use of any such terms, as defined herein, should not be taken to limit the spirit and scope of embodiments of the present disclosure.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

FIG. 1 illustrates an example system architecture 100 within which embodiments of the present disclosure may operate. The system architecture 100 includes a component management system 105 configured to interact with one or more client devices 102A-C, such as client device 102A, client device 102B, and client device 102C. In one or more embodiments, the one or more client devices 102A-C may be configured to interact with one or more components managed by the component management system 105. For example, in one or more embodiments, the one or more client devices 102A-C may be configured to send data to the one or more components managed by the component management system 105 and/or receive data from the one or more components managed by the component management system 105. In an embodiment, the component management system 105 can be associated with an application framework. In one or more embodiments, the component management system 105 may be configured to receive one or more component score interface requests from the client devices 102A-C, retrieve a component metadata vector associated with one or more component identifiers based at least in part on the one or more component score interface requests, generate one or more component scores and one or more component score interfaces to be transmitted to one or more client devices 102A-C. In one or more embodiments, the one or more component score interface requests may include one or more component metadata vector identifiers and/or one or more component identifiers. For example, in one or more embodiments, the one or more component identifiers may identify the one or more components. Furthermore, in one or more embodiments, the one or more component metadata vector identifiers may indicate one or more component score types for one or more components associated with the one or more component identifiers. Additionally or alternatively, in one or more embodiments, the one or more component metadata vector identifiers may indicate a request to initiate one or more component score processes to generate a component score for one or more component score types and/or one or more component scores for one or more components associated with the one or more component identifiers, generate an aggregate component score, and/or other information.

The component management system 105 may communicate with the client devices 102A-C using a network 104. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

A client device from the one or more client devices 102A-C may include a mobile device, a smart phone, a tablet computer, a laptop computer, a wearable device, a personal computer, an enterprise computer, a virtual reality device, or another type of computing device. In one or more embodiments, a client device from the one or more client devices 102A-C includes geolocation circuitry configured to report a current geolocation of the client device. In some embodiments, the geolocation circuitry of the client device may be configured to communicate with a satellite-based radio-navigation system such as the global position satellite (GPS), similar global navigation satellite systems (GNSS), or combinations thereof, via one or more transmitters, receivers, the like, or combinations thereof. In some embodiments, the geolocation circuitry of the client device may be configured to infer an indoor geolocation and/or a sub-structure geolocation of the client device using signal acquisition and tracking and navigation data decoding, where the signal acquisition and tracking and the navigation data decoding is performed using GPS signals and/or GPS-like signals (e.g., cellular signals, etc.). Other examples of geolocation determination include Wi-Fi triangulation and ultra-wideband radio technology.

The component management system 105 may include a component management server 106 and a component object repository 107. The component management server 106 may be configured to retrieve metadata associated with the one or more component identifiers included in the one or more component score interface requests. In one or more embodiments, the component management server 106 may be configured to retrieve component object data. For example, in one or more embodiments, the component management server 106 may be configured to retrieve respective component object identifiers for the one or more component identifiers. The component object repository 107 may store data associated with one or more component objects associated with the component management system 105. Additionally or alternatively, the component object repository 107 may store data associated with one or more event streams for the one or more component objects. For example, the component object repository 107 may store data associated with component object data, component dependency relationships, component object identifiers, performance metrics for the respective component (e.g., processor usage, access logs, crash reports, etc.), encryption keys, hardware requirements, associated computing devices, IP addresses, API compatibility, a host computing device's physical location (e.g., GPS coordinates, country name, etc.), the like, any division, or combinations thereof. The component object repository 107 may include one or more storage units, such as multiple distributed storage units that are connected through a computer network. Each storage unit in the component object repository 107 may store at least one of one or more data assets and/or one or more data about the computed properties of one or more data assets. Moreover, each storage unit in the component object repository 107 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

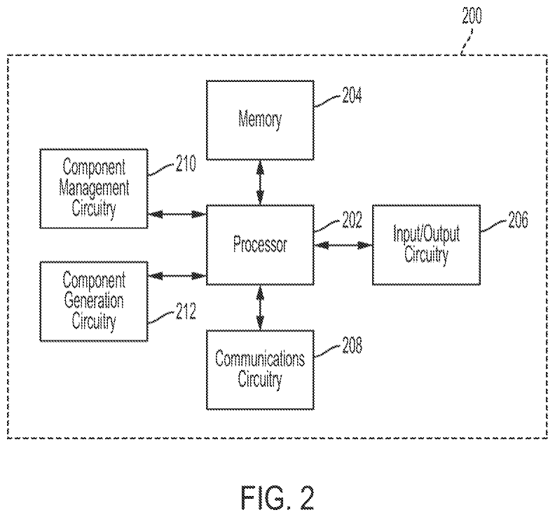

The component management server 106 may be embodied by one or more computing systems, such as apparatus 200 shown in FIG. 2. The apparatus 200 may include processor 202, memory 204, input/output circuitry 206, communications circuitry 208, component management circuitry 210, and component generation circuitry 212. The apparatus 200 may be configured to execute the operations described herein. Although these components 202-212 are described with respect to functional limitations, it should be understood that the particular implementations necessarily include the use of particular hardware. It should also be understood that certain of these components 202-212 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

The component management circuitry 210 may be any means such as a device or circuitry embodied in either hardware or a combination of hardware and software that is configured to manage one or more component score interface requests and/or relate processes associated with the one or more client devices 102A-C. In one or more embodiments, the component management circuitry 210 may be configured to receive one or more component score interface requests from the one or more client devices 102A-C. Additionally, in one or more embodiments, the component management circuitry 210 may be configured to retrieve a component metadata vector comprising a plurality of records associated with one or more component identifiers included in the one or more component score interface requests. The one or more component identifiers may, for example, identify one or more components. Furthermore, in one or more embodiments, the metadata may include respective component object identifiers for the one or more component identifiers. In some embodiments, the metadata provides data associated with component dependency relationships, component object identifiers, performance metrics for the respective component (e.g., processor usage, access logs, crash reports, etc.), encryption keys, hardware requirements, associated computing devices, IP addresses, API compatibility, a host computing device's physical location (e.g., GPS coordinates, country name, etc.), the like, or combinations thereof. In some embodiments, the metadata provides data associated with relationships, sources, targets, ownership, consumption, libraries, activities, attributes, incidents, communication channels, dashboards, data repositories, labels, descriptions, and/or other data related to the one or more component identifiers.

The component generation circuitry 212 may be any means such as a device or circuitry embodied in either hardware or a combination of hardware and software that is configured to determine data for one or more component score interface requests, to generate a component score, generate an aggregate component score, and/or generate a component score interface for the one or more components associated with the one or more component identifiers in the one or more component score interface requests. For instance, in one or more embodiments, the component generation circuitry 212 may be configured to extract one or more component metadata vectors associated with one or more component identifiers included in the one or more component score interface requests. In one or more embodiments, this may be accomplished by querying an associated repository, such as component object repository 107, for each component metadata vector associated with each component identifier. In some embodiments the component generation circuitry 212 is configured to ping one or more computing device associated with one or more components, such as via an internet control message protocol, to receive information related to the one or more components or computing devices (e.g., component object data, etc.). In some embodiments, to obtain component object data associated with one or more client devices and/or one or more components, the component management circuitry 210 utilizes the communications circuitry 208 to transmit one or more API calls to one or more API servers associated with the noted client devices.

In one or more embodiments, a component metadata vector comprises a plurality of records, which each comprise a component metadata record identifier and component metadata value. The component generation circuitry 212 may be configured to extract one or more component metadata values from a component metadata vector based at least in part on a component score type and generate a component score. In some embodiments, the component generation circuitry 212 is configured to generate an aggregate component score based at least in part on the one or more component scores for one or more component scorecards of an organization. In some embodiments, the component generation circuitry 212 is configured to generate a component score interface comprising instructions to render a component score interface element representing a component score and transmit the component score interface to one or more client devices.

In some embodiments the component generation circuitry 212 is configured store received information in the component object repository 107. In some embodiments, the component object repository 107 may comprise one or more of a single unified repository, a single partitioned repository, or a plurality of isolated repositories comprising one or more partitions. An example embodiment of component object repository 107 may comprise separate partitions for isolating sensitive information, for example, classified government data. The component generation circuitry 212 may also be configured to generate access logs and/or historical data including all information previously retrieved that is associated with a particular user, computing device, component, the like, or combinations thereof. Historical data may include component score records and/or component metadata vector records for a particular time interval. For example, when a component metadata vector is retrieved from a component metadata repository and a component score is generated for one or more component score types, this may be the initial time for the component score for one or more component score types. As the component score for one or more component score types is maintained for the component, any modifications to the component score for the one or more component score types may be recorded with a time dimension. For example, if a component metadata value associated with the component metadata vector is modified, the time at which this modification occurs would be associated with a time dimension. Further, the component score for the one or more component score types with which the component metadata vector and/or component metadata value is associated may be updated and associated with a time dimension. This time dimension can then be used to review a changes in component metadata values and/or a component score for the one or more component score types for any given point of time in the past up to the initial start time associated with the component score for the one or more component score types.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

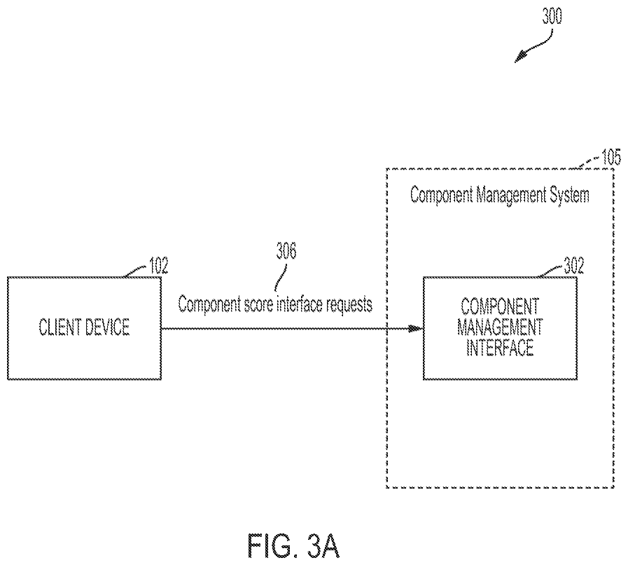

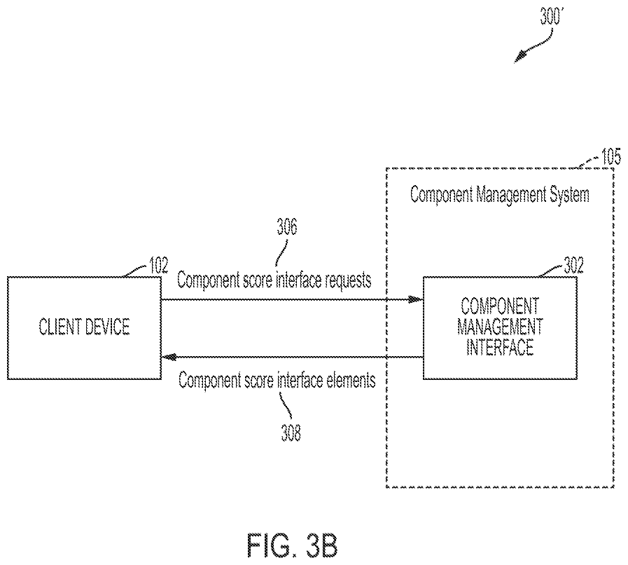

Referring to FIG. 3A, an example system 300 is presented in accordance with one or more embodiments of the present disclosure. The system 300 includes a client device 102 (e.g., a client device from the one or more client devices 102A-C) and the component management system 105. In one or more embodiments, the component management system 105 includes a component management interface 302. The component management interface 302 may be, for example, a computing interface that facilitates exchange of data between the client device 102 and the component management system 105. In one or more embodiments, the component management interface 302 may facilitate management of components and/or component scores related to components associated with the client device 102. In an embodiment, the component management interface 302 may be an API (e.g., a component management API) that facilitates exchange of data between the client device 102 and the component management system 105. For instance, in an embodiment, the component management interface 302 may be an API (e.g., a component management API) to facilitate management of components and/or insights related to components associated with the client device 102. In one or more embodiments, an API (e.g., a component management API) can be an interface that is consumed and/or employed by one or more systems (e.g., one or more of the client devices 102A-C and/or the component management system 105).

In an embodiment, the client device 102 may provide a component score interface request 306 to the component management system 105. For instance, in an embodiment, the component score interface request 306 provided by the client device 102 may be received by the component management interface 302 of the component management system 105. In one or more embodiments, the client device 102 may transmit the component score interface request 306 to the component management system 105 via the network 104. The component score interface request 306 may include one or more component vector score identifiers and/or one or more component identifiers. In one or more embodiments, the component score interface request 306 may be an API call. Based on the component score interface request 306 received via the component management interface 302, the component management system 105 (e.g., the component management circuitry 210) may retrieve metadata, such as a component metadata vector, associated with the one or more component identifiers. In one or more embodiments, the metadata may be retrieved from the component object repository 107. The metadata may include, in one or more embodiments, data associated with relationships, sources, targets, ownership, consumption, libraries, activities, attributes, incidents, communication channels, dashboards, data repositories, labels, descriptions, and/or other data related to the one or more component identifiers.

Referring now to FIG. 3B, an example system 300′ is presented in accordance with one or more embodiments of the present disclosure. In one or more embodiments, the system 300′ illustrates an alternate embodiment of the system 300. The system 300′ includes the client device 102 and the component management system 105. In one or more embodiments, the component management system 105 includes the component management interface 302. In one or more embodiments, in response to the component score interface request 306, the component management system 105 (e.g., the component generation circuitry 212) may determine component vector score interface element(s) 308 associated with the one or more component identifiers indicated in the component score interface request. In one or more embodiments, the component management system 105 may provide the component vector score element(s) 308 to the client device 102. For instance, in an embodiment, the component management system 105 may provide the component vector score element(s) 308 to the client device 102 via the component management interface 302. In one or more embodiments, the component management system 105 may transmit the component vector score element(s) 308 to the client device 102 via the network 104.

In one or more embodiments, the component vector score element(s) 308 may be configured to render visualization of one or more component scores, each associated with a component score type, related to the one or more components via an electronic interface of the client device 102. In one or more embodiments, the one or more component scores for each component score type associated with the component vector score interface element(s) 308 may include contextual information associated with the one or more components, one or more component scores for one or more component score types, one or more component scorecards associated with the one or more components, one or more relationships associated with the one or more components, one or more dependencies associated with the one or more components, one or more categorizations associated with the one or more components, one or more groupings associated with the one or more components, tracking of ownership associated with the one or more components, linking between the one or more components and one or more other tools, structured metadata associated with the one or more components, incident investigation information associated with the one or more components, change management information associated with the one or more components, analytics information associated with the one or more components, and/or one or more other insights associated with the one or more components.

In one or more embodiments, the component vector score interface element(s) 308 may describes one or more inferred properties about an event (e.g., a change event, an incident event, an analytics event etc.) associated with the components. For example, in response to a cluster of components associated with a group of data changes, the component vector score element(s) 308 may include an incident signature that describes data objects and/or components associated with the changes. In another example, in response to a cluster of components associated with a group of data retrieval failures, the component vector score element(s) 308 may include an incident signature that describes data objects in the cluster of components and/or describes that the multi-component system is experiencing a database failure and/or a network connection failure. An event may be associated with an event stream. An event stream may be, for example, a collection of events related to one or more components. In some embodiments, an event may be associated with a unique identifier, one or more attributes, one or more tags, one or more classifications, one or more source identifiers, one or more object types, and/or other context data to facilitate determining one or more inferred properties about the event. Additionally, in some embodiments, an event may be triggered via one or more components. For example, an event may be related to one or more changes and/or one or more incidents related to one or more components. In some embodiments, an event can be an incident event related to a client device (e.g., a client device from client devices 102A-C) such as, for example, a display screen event associated with a client device, a user interface event associated with the client device, a track change event, an operational change, etc. In an embodiment, a display screen event can be related to user navigation to a particular screen, tab, drawer model, inline-dialog and/or other display screen portion via a client device (e.g., a client device from client devices 102A-C). Furthermore, a display screen event can provide information regarding one or more paths taken via a display screen of a client device (e.g., a client device from client devices 102A-C) to perform one or more tasks via the client device. In some embodiments, a display screen event can be associated with identifiable information and/or user generated content to facilitate determining one or more inferred properties about the display screen event.

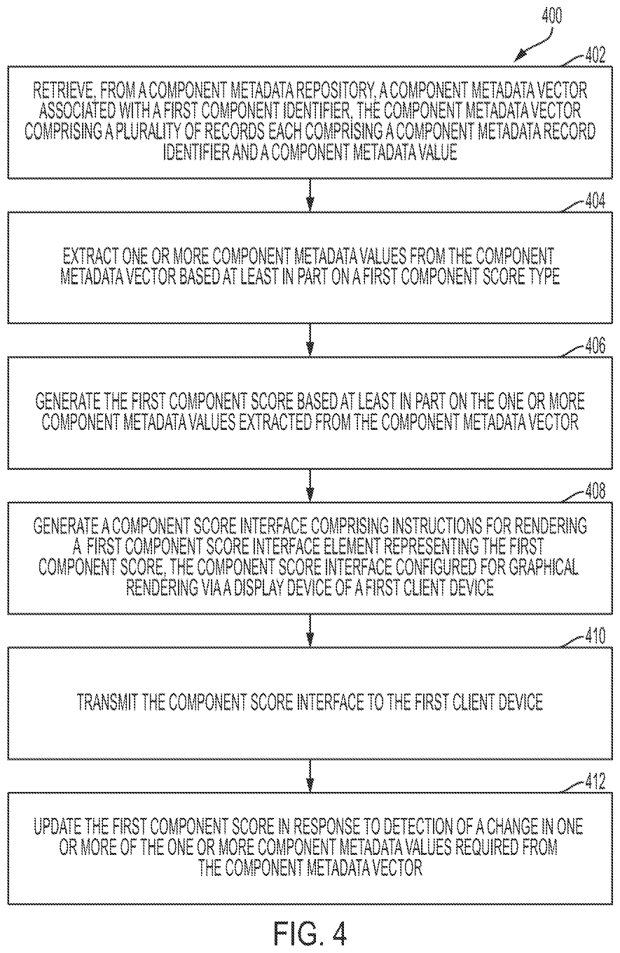

FIG. 4 is a flowchart diagram of an example process 400, for generating a component score interface within a multi-component system, in accordance with, for example, component management system 105. Via the various operations of process 400, the component management server 106, or the like, of the component management system 105 can enhance efficiency, reliability and/or effectiveness of determining the operational health with respect to components of a multi-component system.

The process 400 begins at operation 402 where a component metadata vector associated with a first component identifier is retrieved from a component metadata repository. In some embodiments, the component metadata vector comprises a plurality of records each comprising a component metadata record identifier and a component metadata value. The plurality of records may comprise data associated with relationships, sources, targets, ownership, consumption, libraries, activities, attributes, incidents, communication channels, dashboards, data repositories, labels, descriptions, and/or other data related to the first component identifier.

In some embodiments, the component metadata vector may be retrieved from a component metadata repository in response to receiving a component score interface request as discussed at least with respect to FIG. 3A. In some embodiments, the component score interface request comprises at least a first component identifier. Alternatively, in some embodiments, the component metadata vector may be retrieved from a component metadata repository in response to a change in one or more component metadata values associated with the component metadata vector. In some embodiments, the component management system 105 may be configured to periodically retrieve a component metadata vector from the component metadata repository.

At operation 404, one or more component metadata values are extracted from the component metadata vector based at least in part on a first component score type. In some embodiments, the first component score type defines the one or more component metadata values required from the component metadata vector for generation of a first component score associated with the first component score type. In some embodiments, the component metadata values required from the component metadata are defined in a first metadata values set required from the component metadata vector that is associated with the component score type. For example, if the first component score type is a security operational health component type, component metadata values related to security operational health are extracted from the component metadata vector. As such, only component metadata values relevant to the first component score type may be extracted from the component metadata vector, thus allowing for a more tailored component score for the component score type to be determined.

In some embodiments, the first component score type may be indicated in the component score interface request. Additionally or alternatively, the first component score type may be determined by the component management system 105. For example, if a component score type of a component is due for a periodic update, the component management system 105 may automatically select the component score type for the component and extract the corresponding one or more component metadata values from the component metadata vector. Additionally or alternatively, the component management system 105 may detect a change in one or more component metadata values associated with the component metadata vector and determine the first component score type associated with the one or more changed component metadata values.

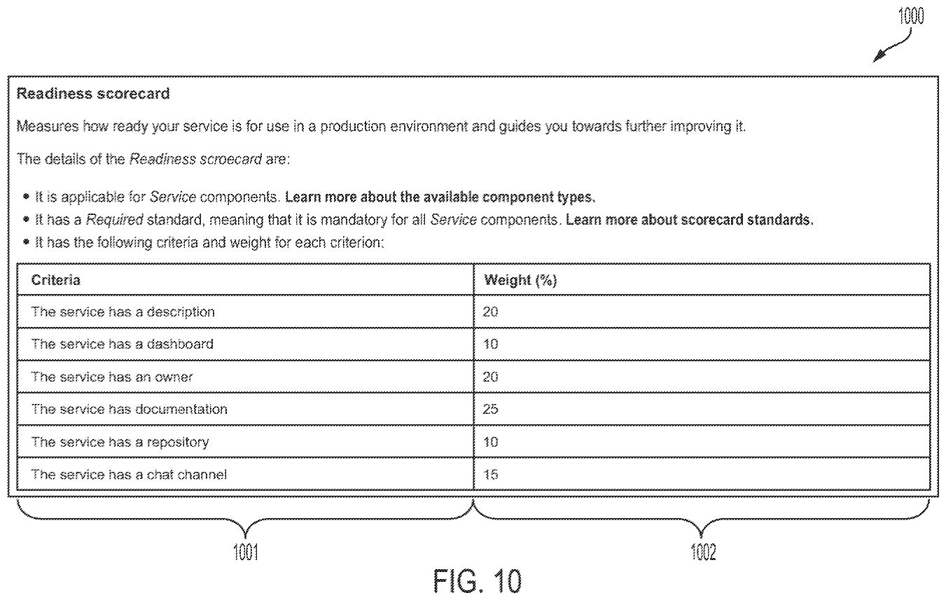

FIG. 10 depicts an operational example of a component scorecard 1000. In particular, component scorecard with a readiness component score type is depicted. The readiness component score type may be associated with one or more unique weights 1002 for one or more component labels, which may each be associated with one or more component metadata values. The component labels 1001 may be associated with a particular component metadata value. For example, a component label may be associated with whether a component metadata value is indicative of a service being associated with an owner. The component label may be associated with a 20% weight such that if a component metadata value is indicative of a service being associated with an owner, the component scorecard 1000 receives the full 20% associated unique weight. If not, the component scorecard 1000 receives the 0% of the full 20% associated unique weight for the component label.

At operation 406, a first component score is generated based at least part on the extracted component metadata values. The component score may be generated by applying a unique weight value to each component metadata value of the one or more component metadata values in accordance with the first component score type. In some embodiments, the unique weight applied to each extracted component metadata value is defined in the corresponding first metadata values set for the first component score type. The resulting values for each component metadata value may be combined using one or more mathematical operations, such as by summing each resulting value, to yield a component metadata score.

In some embodiments, the first component score that is generated may exceed a maximum component score as defined by the corresponding first metadata values set for the first component score type. In such an instance, the first component score is capped at the maximum component score such that the first component score value is equal to the maximum component score. Additionally, in some embodiments, the first component score that is generated may be a non-integer value. The component management system 105 may round the non-integer value to the nearest integer value, such as by performing a floor operation, ceiling operation, or round operation. Alternatively, the resulting values for each component metadata value may be similarly rounded round to the nearest integer value, such as by performing a floor operation, ceiling operation, or round operation, such that the resulting value for each component metadata value is an integer and the combination of the resulting values is an integer value.

At operation 408, a component score interface comprising instructions for rendering a first component score interface element representing the first component score may be generated. The component score interface may be configured for graphic rendering via a display device of a first client device. In some embodiments, the component score interface may configured to display the first component score for the first component score type. In some embodiments, the component score interface may be configured to display a number of additional elements such as the component corresponding to the first component score type, the first component score type, a historical representation of the first component score over time, information related to the component corresponding to the first component score type, and the like.

At operation 410, a component score interface may be transmitted to the first client device. In one or more embodiments, the component score interface can be configured to render visualization of the first component score for the first component score type associated with the respective component identifier via the electronic interface of the client device. In some embodiments, the component management system 105 may transmit the component score interface by providing the component score interface element(s) to the first client device. For instance, in an embodiment, the component management system 105 may provide the component score interface element(s) 308 to the client device 102 via the component management interface 302. In one or more embodiments, the component management system 105 may transmit the component score interface element(s) 308 to the client device 102 via the network 104.

In some embodiments, the first client device may be configured to display the component score interface to a user such as via an associated display. The component score interface may be display to one or more users via the associated display such that the one or more users may visualize the component score for the component score type.

Optionally, at operation 412, a component score interface may be updated in response to detection of a change in one or more of the one or more component metadata vector values required from the component metadata vector. For example, if a component metadata vector value that was extracted and used in part to generate a first component score for the first component score type, is changed or otherwise modified, the component management system 105 may determine to update the first component score. In some embodiments, the component management system 105 receives the one or more updated component metadata values from one or more client devices 102A-C and, in response may compare the one or more updated components metadata values received from the one or more client devices to the one or more component metadata values currently stored, such as in component object repository 107. If the one or more component metadata values received from the one or more client devices do not match the one or more component metadata values currently stored, the component management system 105 may detect a change in the one or more component metadata vector values. As such, the first component score may be maintained in real-time or near real-time and the component score for the first component score type is accurate and up-to-date.

Although the above are described for a first component score type and first component score, it will be appreciated that the above operations may be repeated and/or performed simultaneously for any number of component score types and/or component scores.

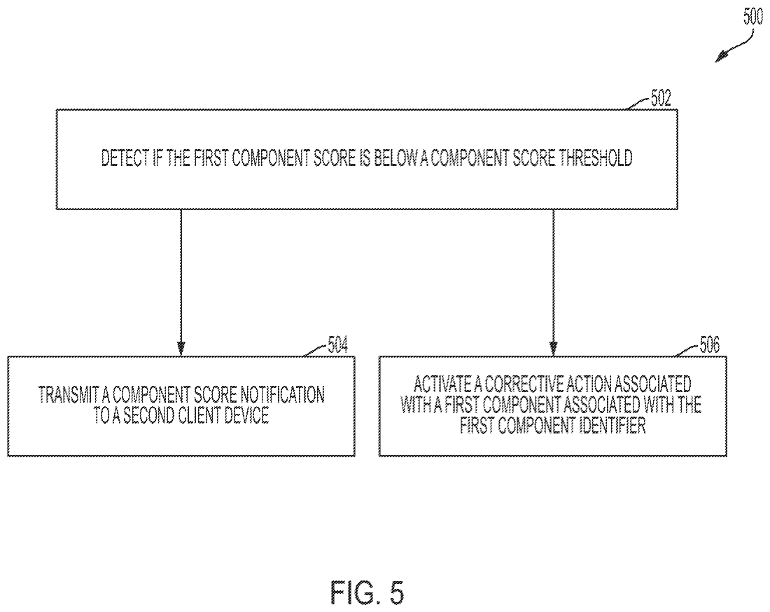

FIG. 5 is a flowchart diagram of an example process 500, for detecting if a first component score is below a component score threshold, in accordance with, for example, component management system 105. Via the various operations of process 500, the component management system 105, or the like, can enhance efficiency, reliability and/or accuracy of determining an component scores for a component score type in real-time with respect to component metadata associated with components of a multi-component system.

The process 500 begins at operation 502 where a first component score is detected below a component score threshold. In some embodiments, the component management system 105 may be receive an updated component metadata value from one or more client devices. In some embodiments, the component management system 105 may be automatically configured to periodically query and/or extract metadata values from one or more client devices. In some embodiments, the component management system 105 may receive a request to update a component score and query and/or extract metadata values from one or more client devices. An updated first component score for a first component score types may then be generated using the updated component metadata values.

Regardless of the circumstances of how the component management system 105 detects the first component score is below a threshold score, the component management system 105 may detect that a first component score is below a component score threshold. In such an instance, the component management system 105 may proceed to operation 504 and/or operation 506.

In some embodiments, an aggregate component score may be generated based at least in part on whether the first component score satisfies a component score threshold. In some embodiments, the aggregate component score is determined based at least each component score for the one or more component scorecards, including the first component score for the first component scorecard. In some embodiments, an aggregate component score value may be represented as a percentage, count, duration, and/or the like. For example, if an organization is associated with ten component scorecards, an aggregate component score may be determined based at least in part on the number of the associated component scorecards which satisfy their respective component score threshold. If five component scorecards are below a component score threshold and five component scorecards are above a component score threshold, an aggregate component score may be 50%, for example.

The aggregate component score may further be associated with a component score threshold which an aggregate component score must satisfy. In some embodiments, an aggregate component score which does not satisfy the aggregate component score threshold may indicate the organization is not of satisfactory operational health based at least in part on the one or more component scorecards associated with the organization. In one or more embodiments, the aggregate component score threshold is configurable by one or more users such that the aggregate component score threshold may be adjusted according to a user's desired preferences. In one or more embodiments, if an aggregate component score fails to satisfy an aggregate component score threshold, for instance, such as when one or more component scorecards are associated with one or more component scores below a component score threshold, one or more actions may be taken in response. In one or more embodiments, the one or more actions may include but is not limited to transmitting an aggregate component score notification to a client device.

At operation 504, responsive to detecting a first component score is below a component score threshold, a component score notification is transmitted to a second client device. In some embodiments, the second client device is a device associated with one or more component metadata values that were changed. In some embodiments, the second client device is a device associated with one or more administrators associated with the first component. In some embodiments, the component score notification refers to an indication indicative of a component score, component score status, or otherwise a component relating to a component scorecard. In this way, one or more users of the second client device are notified that the first component score has dropped below a component score threshold.

At operation 506, in some embodiments, responsive to detecting a first component score is below a component score threshold, a corrective action associated with a first component associated with the first component identifier may be activated. In some embodiments, one or more corrective actions may include determining one or more causes of why a component score failed to satisfy a component score threshold, transmitting a component score notification, performing one or more tasks associated with correcting the cause of why a component score failed to satisfy a component score threshold, etc. As such, the one or more corrective actions may notify one or more users that a first component score no longer satisfies a component score threshold, provide one or more causes as to why the first component score does not satisfy the component score, and/or may perform one or more tasks such that the first component score no longer fails to satisfy the component score threshold.

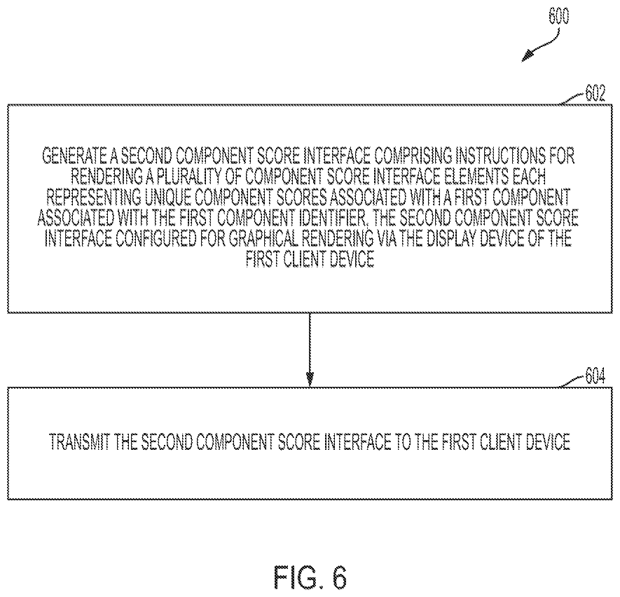

FIG. 6 is a flowchart diagram of an example process 600, for generating a second component score interface, in accordance with, for example, component management system 105.

The process 600 begins at operation 602 where a second component score interface comprising instructions for rendering a plurality of component score interface elements is generated. Each component score interface element may represent unique component scores associated with a first component associated with the first component identifier. The second component score interface may be configured for graphical rendering via the display device of the first client device similarly to that described above. As such, the second component score interface may be configured to display one or more additional component score interface elements associated with the component aside from the component score interface elements associated with the first component score type.

At operation 604, the second component score interface may be transmitted to the first client device. In one or more embodiments, the second component score interface can be configured to render visualization of the second component score for the first component score type associated with the respective component identifier via the electronic interface of the client device. In some embodiments, the component management system 105 may transmit the component score interface by providing the component score interface element(s) to the first client device. Operation 604 may be substantially similar to operation 410.

In some embodiments, the first client device may be configured to display the second component score interface to a user such as via an associated display. The second component score interface may be display to one or more users via the associated display such that the one or more users may visualize the component score for the component score type.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

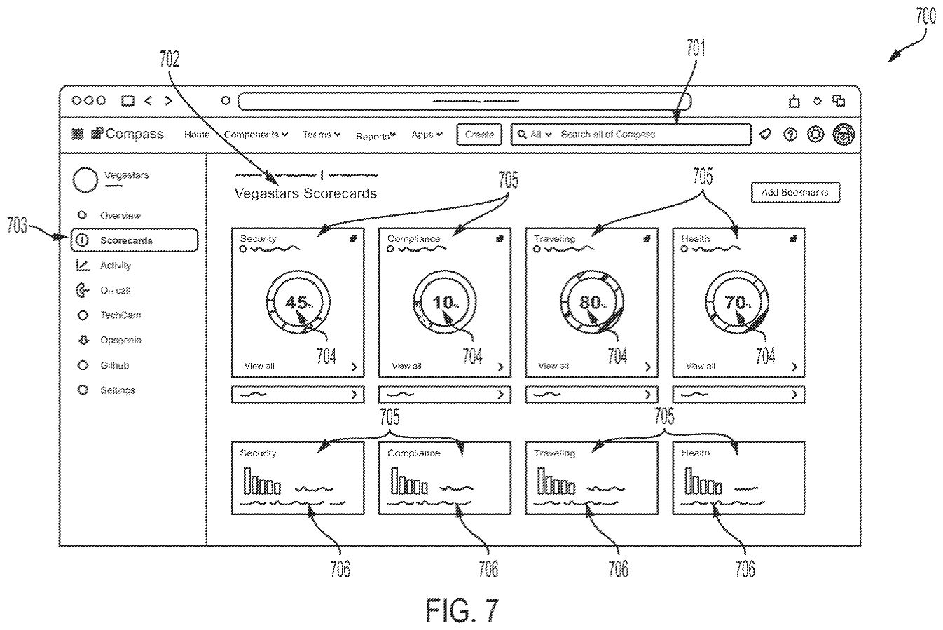

Referring to now FIG. 7, an example user interface is presented in accordance with one or more embodiments of the present disclosure. The user interface 700 (e.g., Compass™ by Atlassian) can be, for example, an electronic interface (e.g., a graphical user interface) of a client device (e.g., the client device 102). In one or more embodiments, the user interface 700 includes a search graphical control element 701. The search graphical control element 701 can facilitate a search with respect to one or more component scores for one or more components of an application framework. For instance, a name of a component and/or a type of component can be provided to the search graphical control element 701 (e.g., via user input data) to initiate a component score process to obtain one or more component scores associated with the components and/or one or more other components. In one or more embodiments, the search graphical control element 701 can initiate generation of the component score interface request 306. In one or more embodiments, the search graphical control element 701 facilitates a request to register a component with a component management system. In one or more embodiments, the user interface 700 provides visualization of component data 702 related to a component (e.g., a name of a component) associated with the search graphical control element 701. In one or more embodiments, the component data 702 displays information related to one or more components that match a textual string provided to the search graphical control element 701.

In one or more embodiments, the user interface 700 additionally or alternatively provides a visualization of component score interface view 703 related to a component (e.g., a name of a component) associated with the search graphical control element 701. The visualization of component score interface view 703 may be a shortcut to access one or more component scores corresponding to one or more component score types for a component.

The user interface 700 may display the component scores 704 for one or more component score types 705. Here, the component view for the component score is represented as a circular representation. In some embodiments, the component scores may be rendered as a percentage and said percentage may be visually depicted in a variety of ways. For example, the component score percentage may be depicted as a colored portion of a circle representative of the component score percentage. Furthermore, the color of the colored portion may be indicative of the status of each component score of the one or more component scores. For example, if the component score is below a component score threshold, the colored portion may be red. As another example, if the component score is above the component score threshold within a particular amount and/or percentage of the component score threshold, the colored portion may be yellow. As yet another example, if the component score of the one or more component thresholds is significantly above the particular amount and/or percentage of the component score threshold, the colored portion may be green. As such, the status of the component score type may be indicated visually.

In some embodiments, a historical representation 706 of the one or more components score types 705 may be displayed. In some embodiments, the one or more historical representations 706 may further be associated with one or more component values, such as a historical component score average.

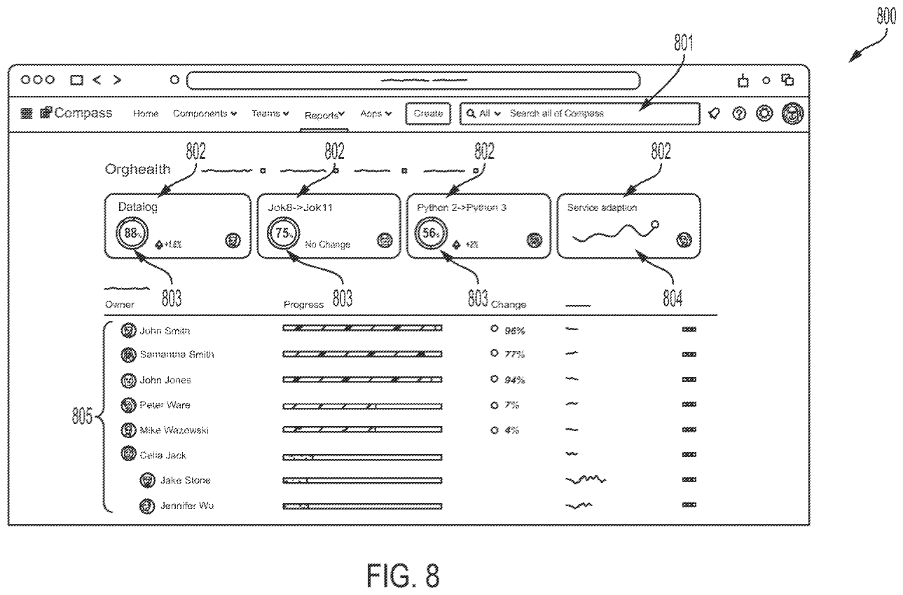

Referring to now FIG. 8, an example user interface 800 is presented in accordance with one or more embodiments of the present disclosure. The user interface 800 (e.g., Compass™ by Atlassian) can be, for example, an electronic interface (e.g., a graphical user interface) of a client device (e.g., the client device 102). In one or more embodiments, the user interface 800 includes a search graphical control element 801. The search graphical control element 801 can facilitate a search with respect to one or more insights for one or more components of an application framework. For instance, a name of a component and/or a type of component can be provided to the search graphical control element 801 (e.g., via user input data) to initiate an component scoring process to obtain one or more component scores for one or more component score types associated with the components and/or one or more other components. In one or more embodiments, the search graphical control element 801 can initiate generation of the component score interface request 306. In one or more embodiments, the search graphical control element 801 facilitates a request to register a component with a component management system. In one or more embodiments, the user interface 800 provides visualization of component data related to a component (e.g., a name of a component) associated with the search graphical control element 801. In one or more embodiments, the component score type 802 displays information related to one or more components that match a textual string provided to the search graphical control element 801.

The user interface 800 may display the component scores 803 for one or more component score types 802. Here, the component view for the component score is represented as a list representation. In some embodiments, the component scores may be rendered as a percentage and said percentage. In some embodiments, a historical representation of the one or more components 804 may be displayed. In some embodiments, the one or more historical representations may show the trend of the component score and/or other details pertaining to the component over time. In some embodiments, a historical score change may be included as a change in a component score over time. For example, in a datalog component score type 802, a 1.6% increase in the associated component score may be indicated.

In one or more embodiments, user interface 800 facilitates visualization of a list of components 805 via a component list view that is grouped and/or ranked by name, type, tier, and/or owner. In some embodiments, each component score in the component list view may depict the component score as a percentage and include a colored portion indicative of the status of each component score of the one or more component scores. For example, if the component score is below a component score threshold, the colored portion may be red. As another example, if the component score is above the component score threshold within a particular amount and/or percentage of the component score threshold, the colored portion may be yellow. As yet another example, if the component score of the one or more component thresholds is significantly above the particular amount and/or percentage of the component score threshold, the colored portion may be green. As such, the status of the component score type may be indicated visually. In some embodiments, a historical score change may be with the list of components 805. The historical score change may include a change in the component score for the component score type over a predetermined time period within a particular grouping. For example, a component score associated with an owner “John Smith” may have a historical score change of a 96% increase.

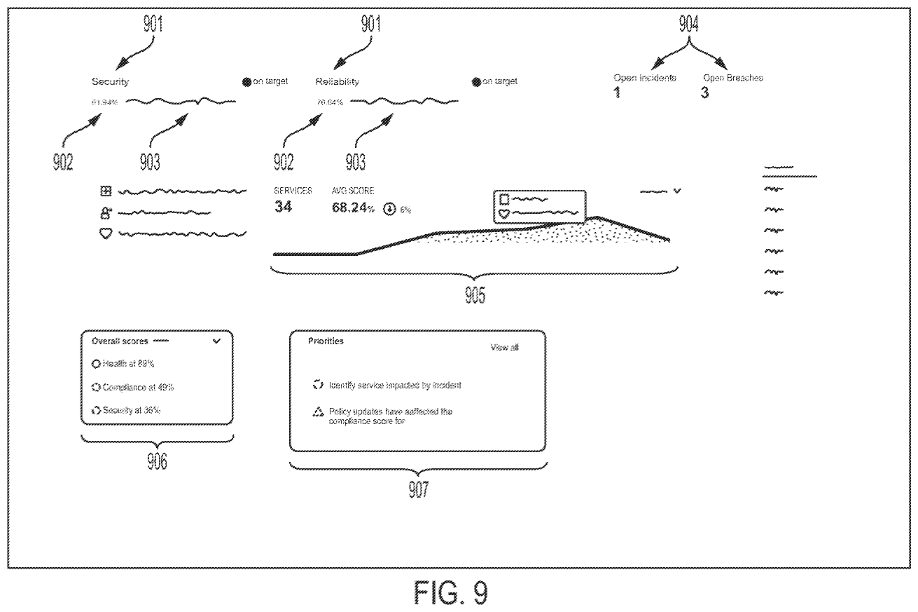

Referring to now FIG. 9, an example user interface 900 is presented in accordance with one or more embodiments of the present disclosure. The user interface 900 can be, for example, an electronic interface (e.g., a graphical user interface) of a client device (e.g., the client device 102).

The user interface 900 may display the component scores 902 for one or more component score types 901. In some embodiments, the component scores may be rendered as a percentage. In some embodiments, a historical representation of the one or more components 903 may be displayed. In some embodiments, the one or more historical representations may show the trend of the component score and/or other details pertaining to the component over time.

In one or more embodiments, user interface 900 facilitates visualization of a list of components 805 via a component list view 906 that is grouped and/or ranked by name, type, tier, and/or owner.

In some embodiments, each component score type in a component list view 906 may depict the component score for each component score type. Furthermore, the status of each component score type may be associated with a color indicative of the status of each component score of the one or more component scores. For example, if the component score is below a component score threshold, the colored portion may be red. As another example, if the component score is above the component score threshold within a particular amount and/or percentage of the component score threshold, the colored portion may be yellow. As yet another example, if the component score of the one or more component thresholds is significantly above the particular amount and/or percentage of the component score threshold, the colored portion may be green. As such, the status of the component score type may be indicated visually.

In some embodiments, one or more detected reasons 907 for lowering of a component score may be visually depicted. The one or more detected reasons 907 may be indicative of why a component score for a component score type decrease and/or did not meet a component score threshold. In some embodiments, a summary of the one or more detected reasons 904 may be depicted. Additionally or alternatively, in some embodiments, a historical representation of a component score 905 may be depicted alongside with the one or more detected reasons for a component score decrease and/or when a component score did not meet a component score threshold.

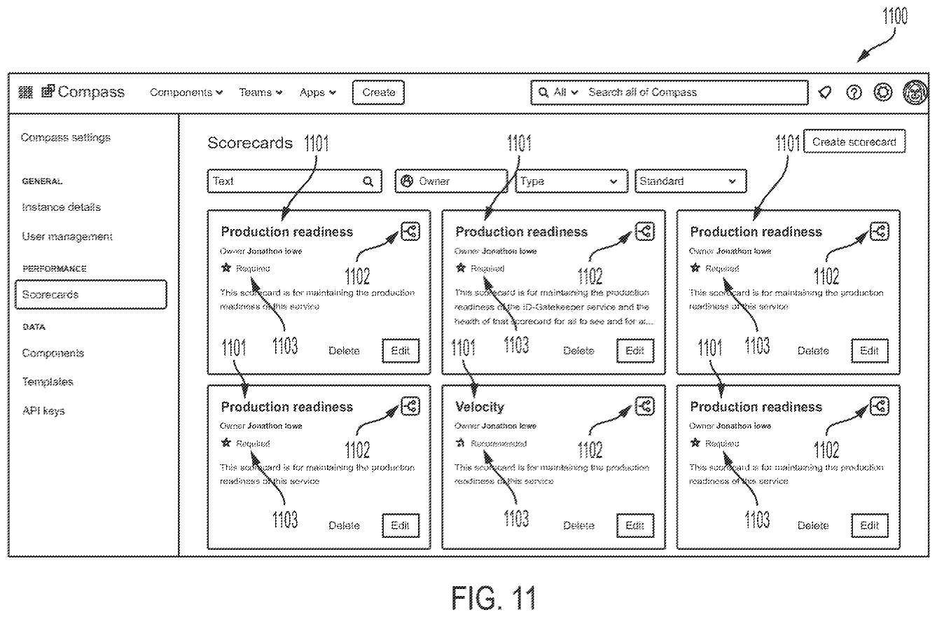

Referring to now FIG. 11, an example user interface 1100 is presented in accordance with one or more embodiments of the present disclosure. The user interface 1100 (e.g., Compass' by Atlassian) can be, for example, an electronic interface (e.g., a graphical user interface) of a client device (e.g., the client device 102).

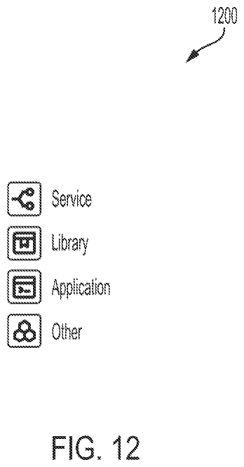

The user interface 1100 may display one or more component scorecards 1101 for an associated user. The one or more component scorecards 1101 may each be associated with a component scorecard component type 1102. The component scorecard component type include a service type, library type, application type, and/or other type. In some embodiments, the component scorecard component type may be indicated via symbolically using one or more component scorecard component type symbols. For example, FIG. 12 depicts one or more component scorecard component types and the associated scorecard type symbols.

In one or more embodiments, user interface 900 facilitates visualization of the one or more component scorecards 1101 and the associated importance classification. Such importance classification may include but is not limited to a required, recommended, or custom importance classification. Component score types classified as a required will automatically be applied to a component when generating a component scores for a component scorecard and may not be removed. Component score types classified as recommended will be suggested as component score types to add to a component scorecard. Component score types classified as custom may be primarily focused on specific use cases for a particular user, team, department, etc. and may be added to a component scorecard by one or more users. The importance classification may also be depicted visually by an importance classification symbol 1103 and a color indicative of the importance classification. For example, if the component scorecard is associated with a required importance classification, the importance classification symbol may be purple. As another example, if the component scorecard is associated with a recommended importance classification, the importance classification symbol may be yellow.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web components, web services, web microservices, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A system for providing a component score interface within a multi-component system, the system comprising one or more computers and one or more storage devices storing instructions that are operable, when executed by the one or more computers, to cause the one or more computers to:
retrieve, from a component metadata repository, a component metadata vector associated with a first component identifier, the component metadata vector comprising a plurality of records each comprising a component metadata record identifier and a component metadata value;
based at least in part on a first component score type, extract one or more component metadata values from the component metadata vector, wherein the first component score type defines the one or more component metadata values required from the component metadata vector for generation of a first component score associated with the first component score type;
generate the first component score based at least in part on the one or more component metadata values extracted from the component metadata vector, wherein generating the first component score comprises applying a unique weight value to each component metadata value of the one or more component metadata values in accordance with the first component score type;
generate a component score interface comprising instructions for rendering a first component score interface element representing the first component score, the component score interface configured for graphical rendering via a display device of a first client device; and
transmit the component score interface to the first client device.

2. The system of claim 1, wherein the one or more storage devices store instructions that are operable, when executed by the one or more computers, to further cause the one or more computers to:
update the first component score in response to detection of a change in one or more of the one or more component metadata values required from the component metadata vector.

3. The system of claim 1, wherein a component score type is one or more of a security score, compliance score, health score, operational health score, readiness score, reliability score, or a custom score.

4. The system of claim 1, wherein the first component score type is associated with a first metadata values set required from the component metadata vector for generation of the first component score.

5. The system of claim 1, wherein the one or more storage devices store instructions that are operable, when executed by the one or more computers, to further cause the one or more computers to:
generate the first component score in response to receiving a component score interface request from the first client device.

6. The system of claim 1, wherein the one or more storage devices store instructions that are operable, when executed by the one or more computers, to further cause the one or more computers to:
responsive to detecting that the first component score is below a component score threshold associated with the component score type, transmit a component score notification to a second client device.

7. The system of claim 1, wherein the one or more storage devices store instructions that are operable, when executed by the one or more computers, to further cause the one or more computers to:
responsive to detecting that the first component score is below a component score threshold associated with the component score type, activate a corrective action associated with a first component associated with the first component identifier.

8. The system of claim 1, wherein the one or more storage devices store instructions that are operable, when executed by the one or more computers, to further cause the one or more computers to:
generate a second component score interface comprising instructions for rendering a plurality of component score interface elements each representing unique component scores associated with a first component associated with the first component identifier, the second component score interface configured for graphical rendering via the display device of the first client device; and
transmit the second component score interface to the first client device.

9. The system of claim 1, wherein the one or more values of the component score comprise one or more of a percentage, count, or duration.

10. A computer-implemented method, comprising:
retrieving, using processing circuitry and from a component metadata repository, a component metadata vector associated with a first component identifier, the component metadata vector comprising a plurality of records each comprising a component metadata record identifier and a component metadata value;
based at least in part on a first component score type, extracting, using the processing circuitry, one or more component metadata values from the component metadata vector, wherein the first component score type defines the one or more component metadata values required from the component metadata vector for generation of a first component score associated with the first component score type;
generating, using the processing circuitry, the first component score based at least in part on the one or more component metadata values extracted from the component metadata vector, wherein generating the first component score comprises applying a unique weight value to each component metadata value of the one or more component metadata values in accordance with the first component score type;
generating, using the processing circuitry, a component score interface comprising instructions for rendering a first component score interface element representing the first component score, the component score interface configured for graphical rendering via a display device of a first client device; and
transmitting, using the processing circuitry, the component score interface to the first client device.

11. The method of claim 10, further comprising:
updating the first component score in response to detection of a change in one or more of the one or more component metadata values required from the component metadata vector.

12. The method of claim 10, wherein a component score type is one or more of a security score, compliance score, health score, operational health score, reliability score, readiness score or a custom score.

13. The method of claim 10, wherein the first component score type is associated with a first metadata values set required from the component metadata vector for the generation of the first component score.

14. The method of claim 10, further comprising:
generating the first component score in response to a component score interface request from the first client device.

15. The method of claim 10, further comprising:
responsive to detecting that the first component score is below a component score threshold associated with the component score type, transmitting a component score notification to a second client device.

16. The method of claim 10, further comprising:
responsive to detecting that the first component score is below a component score threshold associated with the component score type, activating a corrective action associated with a first component associated with the first component identifier.

17. The method of claim 10, further comprising:
generating a second component score interface comprising instructions for rendering a plurality of component score interface elements each representing unique component scores associated with a first component associated with the first component identifier, the second component score interface configured for graphical rendering via the display device of the first client device; and
transmitting the second component score interface to the first client device.

18. The system of claim 1, wherein the one or more values of the component score comprise one or more of a percentage, count, or duration.

19. A computer program product, stored on a computer readable medium, comprising instructions that when executed by one or more computers cause the one or more computers to:
retrieve, from a component metadata repository, a component metadata vector associated with a first component identifier, the component metadata vector comprising a plurality of records each comprising a component metadata record identifier and a component metadata value;
based at least in part on a first component score type, extract one or more component metadata values from the component metadata vector, wherein the first component score type defines the one or more component metadata values required from the component metadata vector for generation of a first component score associated with the first component score type;
generate the first component score based at least in part on the one or more component metadata values extracted from the component metadata vector, wherein generating the first component score comprises applying a unique weight value to each component metadata value of the one or more component metadata values in accordance with the first component score type;
generate a component score interface comprising instructions for rendering a first component score interface element representing the first component score, the component score interface configured for graphical rendering via a display device of a first client device; and
transmit the component score interface to the first client device.

20. The computer program product of claim 19, further comprising instructions that when executed by one or more computers cause the one or more computers to:
update the first component score in response to detection of a change in one or more of the one or more component metadata values required from the component metadata vector.
